(19) United States
(12) Patent Application Publication
(10) Pub. No.: US 2006/0018515 A1
(43) Pub. Date: Jan. 26, 2006

(54) Biometric data collating apparatus, biometric data collating method and biometric data collating program product

(75) Inventors: Yasufumi Itoh, Tenri-shi (JP); Manabu Yumoto, Nara-shi (JP); Manabu Onozaki, Nara-shi (JP); Mitsuaki Nakamura, Chiba-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka (JP)

(21) Appl. No.: 11/169,758

(22) Filed: Jun. 30, 2005

(30) Foreign Application Priority Data
Jul. 2, 2004 (JP) 2004-197080(P)

(51) Int. Cl. G06K 9/00

(52) U.S. Cl. 382/115

(57) ABSTRACT

In collation determination of an input biometric data and a plurality of reference data stored in advance, when a biometric data collating apparatus according to the invention determines that the reference data matching with the biometric data is present, the biometric data collating apparatus updates a current reference order ordidx of the reference data determined as matching data to Order[0] representing a leading place in a collation order table.

This nonprovisional application is based on Japanese Patent Application No. 2004-197080 filed with the Japan Patent Office on Jul. 2, 2004, the entire contents of which are hereby incorporated by reference.

### BACKGROUND OF THE INVENTION

1. Field of the Invention

The present invention relates to a biometric data collating apparatus, a biometric data collating method and a biometric data collating program product, and particularly to a biometric data collating apparatus, a biometric data collating method and a biometric data collating program product which collates a collation target data formed of biometric information such as fingerprints with a plurality of collation data (i.e., data for collation).

2. Description of the Background Art

As a biometric data collating apparatus employing a biometrics technology, Japanese Patent Laying-Open No. 2003-323618 has disclosed such a biometric data collating apparatus that collates data of biometric information such as fingerprints provided thereto with collation data registered in advance for authenticating personal identification.

However, the conventional biometric data collating apparatus collates the collation target data provided thereto with the plurality of collation data by reading and using the collation data in an order fixed in advance, and cannot dynamically change the collation order for reducing a quantity or volume of processing. This results in problems that a processing quantity required for collation is large on average, and increases in proportion to the number of the registered collation data. Further, the large processing quantity results in a problem that the collation requires a long processing time and large power consumption.

### SUMMARY OF THE INVENTION

An object of the invention is to reduce a processing quantity required for collating the input collation target data.

The above object of the invention can be achieved by a biometric data collating apparatus including the following components. Thus, the biometric data collating apparatus includes a collation target data input unit receiving biometric collation target data; a collation data storing unit storing a plurality of collation data used for collating the collation target data received by the collation target data input unit and an order of collation of the plurality of collation data; a collating unit reading each of the collation data stored in the collation data storing unit in the collation order, and collating the read collation data with the collation target data received by the collation target data input unit; and a collation order updating unit updating the collation order to put the collation data determined as matching data from the result of the collation by the collating unit in a leading place.

According to another aspect of the invention, a biometric data collating apparatus includes a collation target data input unit receiving biometric collation target data; a collation data storing unit storing a plurality of collation data used for collating the collation target data received by the collation target data input unit and priority values representing degrees of priority of collation for the respective collation data; a collating unit reading each of the collation data stored in the collation data storing unit in a descending order of the degree of the priority represented by the priority value, and collating the read collation data with the collation target data received by the collation target data input unit; and a priority value updating unit updating and changing the priority value corresponding to the collation data determined as matching data from the result of the collation by the collating unit into a value representing a higher degree of the priority.

According to still another aspect of the invention, a biometric data collating apparatus further includes a collation order updating unit updating the collation order of each of the collation data in the descending order of the degree of the priority represented by the priority value corresponding to the collation data. The collating unit reads the respective collation data in the collation order, and collates the read collation data with the collation target data received by the collation target data input unit. When the updated priority value corresponding to the collation data determined as the matching data from the result of the collation by the collating unit is larger than or equal to the priority value corresponding to the collation data preceding in the collation order the collation data determined as the matching data, the collation order updating unit replaces the places in the collation order of the above two collation data with each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a biometric information collating apparatus.

FIG. 2 shows a configuration of a computer provided with the biometric information collating apparatus.

FIG. 3 is a flowchart illustrating collation processing.

FIG. 4 is a flowchart illustrating collation determination processing.

FIG. 5 is a process flowchart of template matching and calculation of a similarity score.

FIG. 6 is a flowchart illustrating collation order updating processing of a first embodiment.

FIGS. 7A and 7B illustrate a collation order table.

FIG. 8 is a flowchart illustrating collation order updating processing 2 of a second embodiment.

FIGS. 9A and 9B illustrate a collation order table (including collation frequency tables) of the second embodiment.

### DESCRIPTION OF THE PREFERRED EMBODIMENTS

Embodiments of the invention will now be described with reference to the drawings. A biometric information collating apparatus 1 receives biometric information data, and collates it with reference data (i.e., data for reference) which are registered in advance. Fingerprint image data will be described by way of example as collation target data, i.e., data to be collated. However, the data is not restricted to it, and may be another image data, voice data or the like representing another biometric feature which is similar to those of other individuals or persons, but never matches with them. Also, it may be image data of the striation or image data other than the striation. In the figures, the same or corresponding portions bear the same reference numbers, and description thereof is not repeated.

### First Embodiment

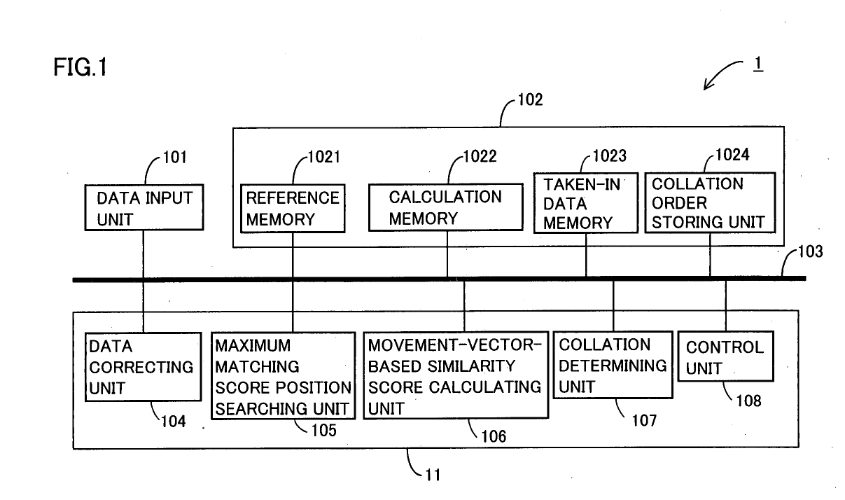

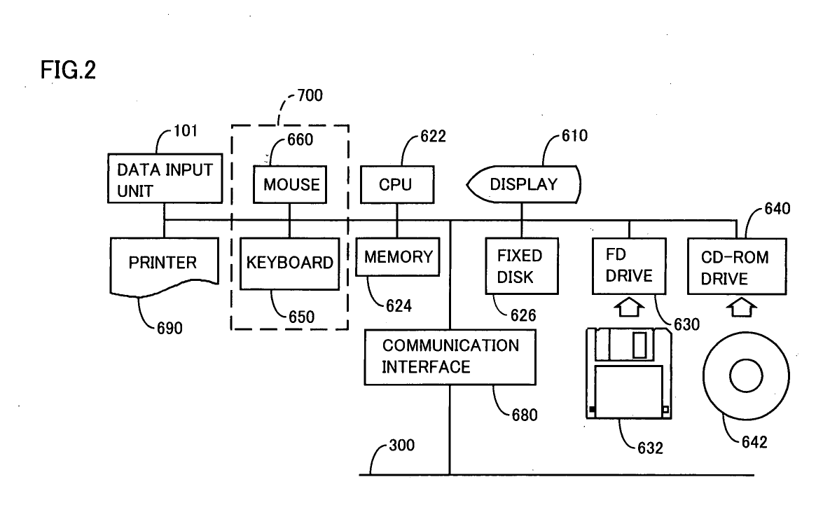

FIG. 1 is a block diagram of biometric information collating apparatus 1 according to a first embodiment. FIG. 2 shows a configuration of a computer provided with biometric information collating apparatus 1 according to each of embodiments.

Referring to FIG. 2, the computer includes a data input unit 101, a display 610 such as a CRT (Cathode Ray Tube) or a liquid crystal display, a CPU (Central Processing Unit) 622 for central management and control of the computer itself, a memory 624 including an ROM (Read Only Memory) or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact Disc Read Only Memory) is detachably mounted and which accesses to mounted CD-ROM 642, a communication interface 680 for connecting the computer to a communication network 300 for establishing communication, a printer 690, and an input unit 700 having a keyboard 650 and a mouse 660. These components are connected through a bus for communication.

The computer may be provided with a magnetic tape apparatus accessing to a cassette type magnetic tape that is detachably mounted thereto.

Referring to FIG. 1, biometric information collating apparatus 1 includes data input unit 101, memory 102 that corresponds to a memory 624 or a fixed disk 626 shown in FIG. 2, a bus 103 and a collation processing unit 11. Memory 102 stores data (image in this embodiment) and various calculation results. Collation processing unit 11 includes a data correcting unit 104, a maximum matching score position searching unit 105, a unit 106 calculating a similarity score based on a movement vector (which will be referred to as a “movement-vector-based similarity score calculating unit” hereinafter), a collation determining unit 107 and a control unit 108. Functions of these units in collation processing unit 11 are realized when corresponding programs are executed.

Data input unit 101 includes a fingerprint sensor, and outputs a fingerprint image data that corresponds to the fingerprint read by the sensor. The sensor may be an optical, a pressure-type, a static capacitance type or any other type sensor.

Memory 102 includes a reference memory 1021 (i.e., memory for reference) storing data used for collation with the fingerprint image data applied to data input unit 101, a calculation memory 1022 temporarily calculating various calculation results, a taken-in data memory 1023 taking in the fingerprint image data applied to data input unit 101, and a collation order storing unit 1024 (i.e., memory for storing a collation order).

Collation processing unit 11 refers to each of the plurality of collation data (i.e., data for collation) stored in reference memory 1021, and determines whether the collation data matches with the fingerprint image data received by data input unit 101 or not. In the following description, the collation data stored in reference memory 1021 will be referred to as “reference data” hereinafter.

Collation order storing unit 1024 stores a collation order table including indexes of the reference data as elements. Biometric information collating apparatus 1 reads the reference data from reference memory 1021 in the order of storage in the collation order table, and collates them with the input fingerprint image data.

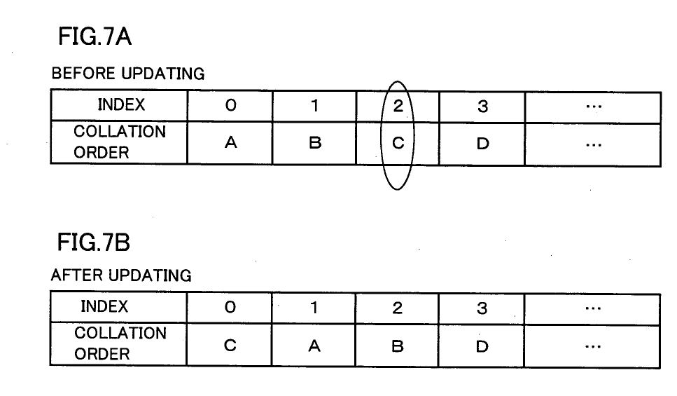

FIGS. 7A and 7B illustrate an example of the collation order table. FIG. 7A illustrates the collation order table representing the collation order before updating. FIG. 7B illustrates the collation order table representing the collation order after updating. Biometric information collating apparatus 1 executes the collation based on the order in this collation order table. When the biometric information collating apparatus 1 is produced (when memory 102 is initialized), the collation order table contains all indexes of the reference data to be used without overlapping.

Bus 103 is used for transferring control signals and data signals between the units. Data correcting unit 104 performs correction (density correction) on data (i.e., fingerprint image in this embodiment) applied from data input unit 101. Maximum matching score position searching unit 105 uses a plurality of partial areas of one data (fingerprint image) as templates, and searches for a position of the other data (fingerprint image) that attains the highest matching score with respect to the templates. Namely, this unit serves as a so-called template matching unit.

Using the information of the result of processing by maximum matching score position searching unit 105 stored in memory 102, movement-vector-based similarity score calculating unit 106 calculates the movement-vector-based similarity score. Collation determining unit 107 determines a match/mismatch, based on the similarity score calculated by similarity score calculating unit 106. Control unit 108 controls processes performed by various units of collation processing unit 11.

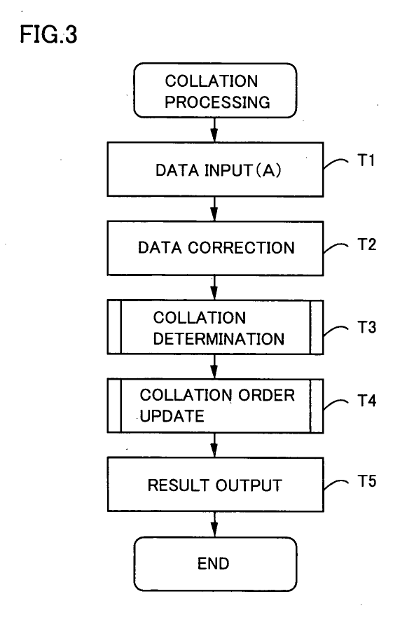

Referring to FIG. 3, description will now be given on the procedures of collating the data (fingerprint image) applied from data input unit 101 with the reference data (fingerprint image) by biometric information collating apparatus 1. FIG. 3 is a flowchart illustrating collation processing of collating the input data with the reference data.

First, data input processing is executed (step T1). In the data input processing, control unit 108 transmits a data input start signal to data input unit 101, and thereafter waits for reception of a data input end signal. Data input unit 101 receiving the data input start signal takes in collation target data A for collation, and stores collation target data A at a prescribed address of taken-in data memory 1023 through bus 103. Further, after the input or take-in of collation target data A is completed, data input unit 101 transmits the data input end signal to control unit 108.

Then, the data correction processing is executed (step T2). In the data correction processing, control unit 108 transmits a data correction start signal to data correcting unit 104, and thereafter, waits for reception of a data correction end signal. In most cases, the input image has uneven image quality, as tones of pixels and overall density distribution vary because of variations in characteristics of data input unit 101, dryness of fingerprints and pressure with which fingers are pressed. Therefore, it is not appropriate to use the input image data directly for collation.

Data correcting unit 104 corrects the image quality of input image to suppress variations of conditions when the image is input (step T2). Specifically, for the overall image corresponding to the input image or small areas obtained by dividing the image, histogram planarization, as described in Computer GAZOU SHORI NYUMON (Introduction to computer image processing), SOKEN SHUPPAN, p. 98, or image thresholding (binarization), as described in Computer GAZOU SHORI NYUMON (Introduction to computer image processing), SOKEN SHUPPAN, pp. 66-69, is performed on collation target data A stored in taken-in data memory 1023. After the end of data correction processing of collation target data A, data correcting unit 104 transmits the data correction end signal to control unit 108.

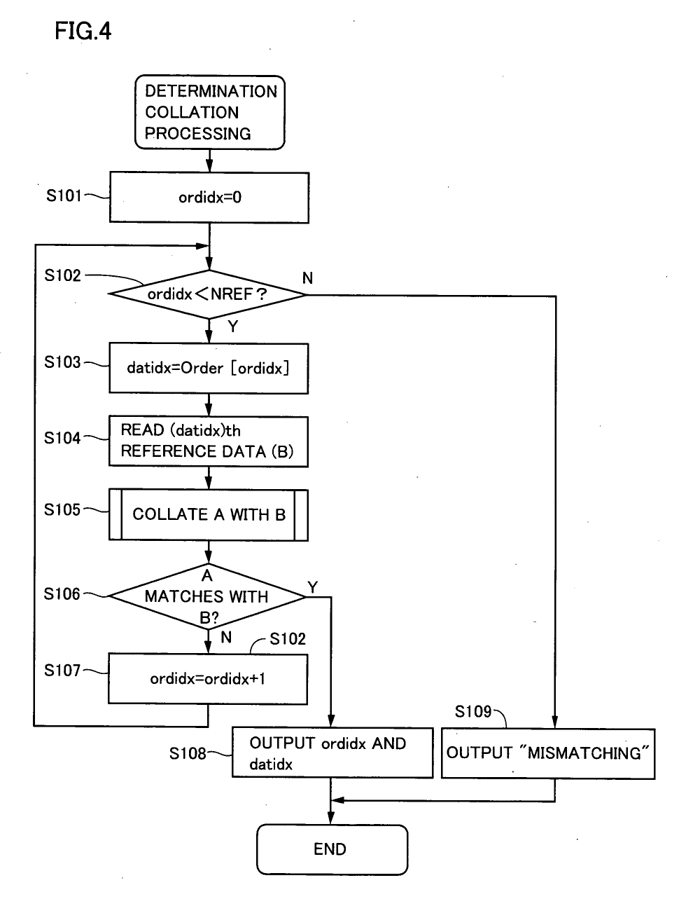

Then, collation determining unit 107 performs collation determination on collation target data A subjected to the data correction processing by data correcting unit 104 and the reference data registered in advance in reference memory 1021 (step T3). The collation determination processing will be described later with reference to FIG. 4.

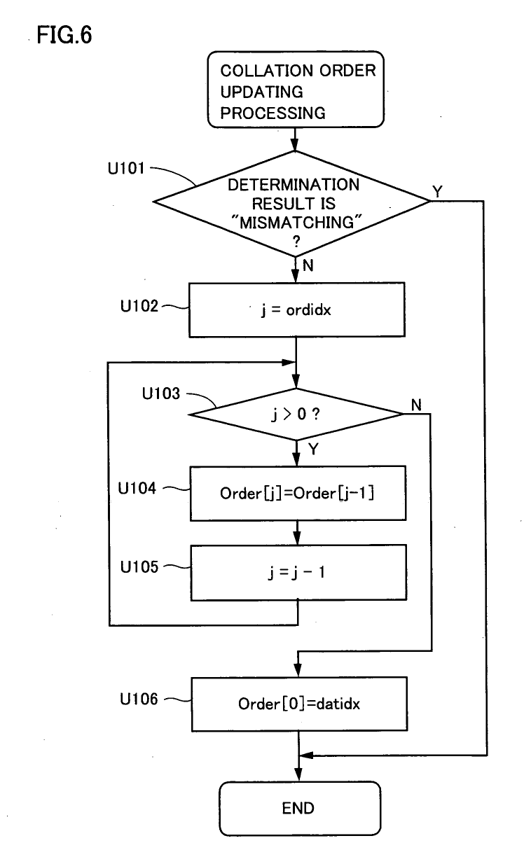

Collation processing unit 11 performs the collation order updating processing (step T4). This processing updates the collation order table (see FIGS. 7A and 7B) stored in collation order storing unit 1024 based on the result of the collation determination in step T3. The collation order updating processing will be described later with reference to FIG. 6.

Finally, control unit 108 outputs the result of the collation determination stored in memory 102 via display 610 or printer 690 (step T5). Thereby, the collation processing ends.

Referring to FIG. 4, the collation determination processing will now be described. The collation determination processing is a subroutine executed in step T3 in FIG. 3. In the following description, elements in the collation order table are expressed such that a first element is Order[0], and a next element is Order[1].

Prior to the collation determination processing, control unit 108 transmits a collation determination start signal to collation determining unit 107, and waits for reception of a collation determination end signal.

In step S101, index ordidx of the element in the collation order table is initialized to 0 (first and thus Oth element).

In step S102, index ordidx of the element in the collation order table is compared with NREF, which is data representing the number of reference data stored in reference memory 1021. When index ordidx of the element in the collation order table is smaller than the number NREF of the reference data, the flow proceeds to step S103.

In step S103, Order[ordidx] is read from collation order storing unit 1024, and the read value is used as a value of a variable datidx.

In step S104, the reference data indicated by index datidx of the reference data is read from reference memory 1021, and the reference data thus read is used as data B.

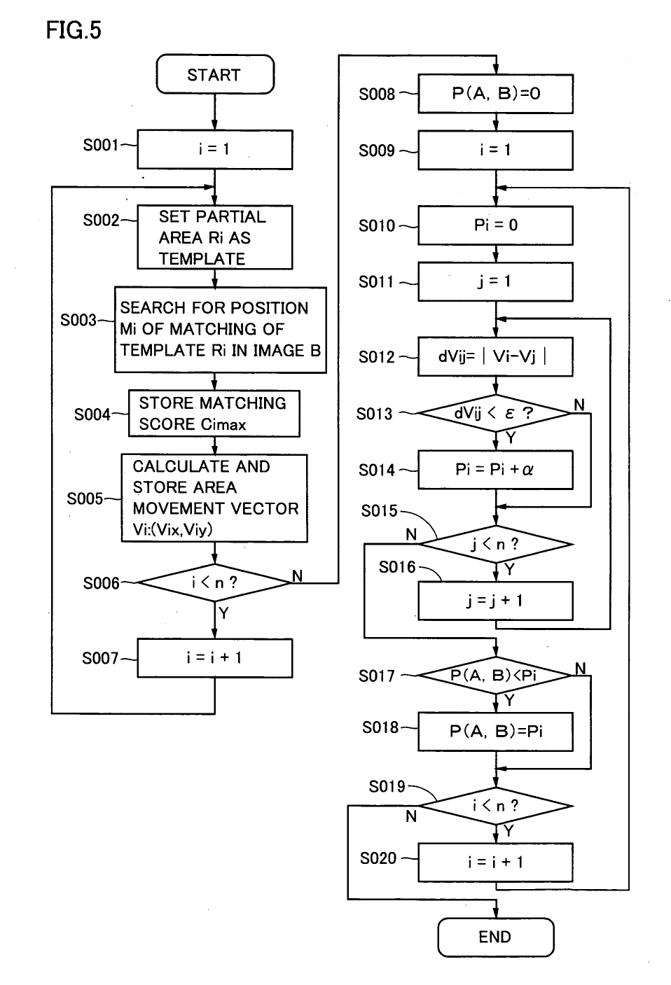

In step S105, processing is performed to collate the input data (data A) with the read reference data (data B). This processing is formed of template matching and calculation of the similarity score. Procedures of this processing are illustrated in FIG. 5. This processing will now be described in detail with reference to a flowchart of FIG. 5.

First, control unit 108 transmits a template matching start signal to maximum matching score position searching unit 105, and waits for reception of a template matching end signal. Maximum matching score position searching unit 105 starts the template matching processing as illustrated in steps S001 to S007. In step S001, a variable i of a counter is initialized to 1. In step S002, an image of a partial area, which is defined as a partial region Ri, is set as a template to be used for the template matching.

Though the partial area Ri has a rectangular shape for simplicity of calculation, the shape is not limited thereto. In step S003, processing is performed to search for a position, where data B exhibits the highest matching score with respect to the template set in step S002, i.e., the position where matching of data in the image is achieved to the highest extent. More specifically, it is assumed that partial area Ri used as the template has an image density of Ri(x, y) at coordinates (x, y) defined based on its upper left corner, and data B has an image density of B(s, t) at coordinates (s, t) defined based on its upper left corner. Also, partial area Ri has a width w and a height h, and each of pixels of data A and B has a possible maximum density of V0. In this case, a matching score Ci(s, t) at coordinates (s, t) of data B can be calculated based on density differences of respective pixels according to the following equation (1).

$$Ci ( s , t ) = {\sum }_{y = 1}^{h} {\sum }_{x = 1}^{w} ( V0 - \vert Ri ( x , y ) - B ( s + x , t + y ) \vert ) \qquad ( 1 )$$

In data B, coordinates (s, t) are successively updated and matching score C(s, t) in coordinates (s, t) is calculated. A position having the highest value is considered as the maximum matching score position, the image of the partial area at that position is represented as partial area Mi, and the matching score at that position is represented as maximum matching score Cimax. In step S004, maximum matching score Cimax in data B for partial area Ri calculated in step S003 is stored at a prescribed address of memory 1022. In step S005, a movement vector Vi is calculated in accordance with the following equation (2), and is stored at a prescribed address of memory 1022.

As already described, processing is effected based on partial area Ri corresponding to position P set in data A, and data B is scanned to determine a partial area Mi in a position M exhibiting the highest matching score with respect to partial area Ri. A vector from position P to position M thus determined is referred to as the “movement vector”. This is because data B seems to have moved from data A as a reference, as the finger is placed in various manners on the fingerprint sensor.
Vi=(Vix,Viy)=(Mix−Rix,Miy−Riy) (2)

In the above equation (2), variables Rix and Riy are x and y coordinates of the reference position of partial area Ri, and correspond, by way of example, to the upper left corner of partial area Ri in data A. Variables Mix and Miy are x and y coordinates of the position of maximum matching score Cimax, which is the result of search of partial area Mi, and correspond, by way of example, to the upper left corner coordinates of partial area Mi located at the matched position in data B.

In step S006, it is determined whether counter variable i is smaller than a maximum value n of the index of the partial area or not. If the value of variable i is smaller than n, the process proceeds to step S007, and otherwise, the process proceeds to step S008. In step S007, 1 is added to the value of variable i. Thereafter, as long as the value of variable i is not larger than n, steps S002 to S007 are repeated. By repeating these steps, template matching is performed for each partial area Ri to calculate maximum matching score Cimax and movement vector Vi of each partial area Ri.

Maximum matching score position searching unit 105 stores maximum matching score Cimax and movement vector Vi for every partial area Ri, which are calculated successively as described above, at prescribed addresses, and thereafter transmits the template matching end signal to control unit 108. Thereby, the process proceeds to step S008.

Thereafter, control unit 108 transmits a similarity score calculation start signal to movement-vector-based similarity score calculating unit 106, and waits for reception of a similarity score calculation end signal. Movement-vector-based similarity score calculating unit 106 calculates the similarity score through the process of steps S008 to S020 of FIG. 5, using information such as movement vector Vi and maximum matching score Cimax of each partial area Ri obtained by the template matching and stored in memory 1022.

In step S008, similarity score P(A, B) is initialized to 0. Here, similarity score P(A, B) is a variable storing the degree of similarity between data A and B. In step S009, index i of movement vector Vi used as a reference is initialized to 1. In step S010, similarity score Pi related to movement vector Vi used as the reference is initialized to 0. In step S011, index j of movement vector Vj is initialized to 1. In step S012, a vector difference dVij between reference movement vector Vi and movement vector Vj is calculated in accordance with the following equation (3).
dVij=|Vi−Vj|=sqrt((Vix−Vjx)ˆ2+(Viy−Vjy)\hat{2}) (3)

Here, variables Vix and Viy represent components in x and y directions of movement vector Vi, respectively, and variables Vjx and Vjy represent components in x and y directions of movement vector Vj, respectively. Variable sqrt(X) represents a square root of X, and Xˆ2 is an equation calculating a square of X.

In step S013, vector difference dVij between movement vectors Vi and Vj is compared with a prescribed constant ε, and it is determined whether movement vectors Vi and Vj can be regarded as substantially the same vectors or not. If vector difference dVij is smaller than the constant ε, movement vectors Vi and Vj are regarded as substantially the same, and the flow proceeds to step S014. If the difference is larger than the constant, the movement vectors cannot be regarded as substantially the same, and the flow proceeds to step S015. In step S014, similarity score Pi is incremented in accordance with the following equations (4) to (6).
Pi=Pi+α (4)
α=1 (5)
α=Cjmax (6)

In equation (4), variable α is a value for incrementing similarity score Pi. If cc is set to 1 as represented by equation (5), similarity score Pi represents the number of partial areas that have the same movement vector as reference movement vector Vi. If α is equal to Cjmax as represented by equation (6), similarity score Pi is equal to the total sum of the maximum matching scores obtained through the template matching of partial areas that have the same movement vectors as the reference movement vector Vi. The value of variable α may be reduced depending on the magnitude of vector difference dVij.

In step S015, it is determined whether index j is smaller than the value n or not. If index j is smaller than n, the flow proceeds to step S016. Otherwise, the flow proceeds to step S017. In step S016, the value of index j is incremented by 1. By the process from step S010 to S016, similarity score Pi is calculated, using the information of partial areas determined to have the same movement vector as the reference movement vector Vi. In step S017, similarity score Pi using movement vector Vi as a reference is compared with variable P(A, B). If similarity score Pi is larger than the largest similarity score (value of variable P(A, B)) obtained by that time, the flow proceeds to step S018, and otherwise the flow proceeds to step S019.

In step S018, variable P(A, B) is set to a value of similarity score Pi using movement vector Vi as a reference. In steps S017 and S018, if similarity score Pi using movement vector Vi as a reference is larger than the maximum value of the similarity score (value of variable P(A, B)) calculated by that time using another movement vector as a reference, the reference movement vector Vi is considered to be the best reference among movement vectors Vi, which have been represented by index i.

In step S019, the value of index i of reference movement vector Vi is compared with the maximum value (value of variable n) of the indexes of partial areas. If index i is smaller than the number of partial areas, the flow proceeds to step S020, in which index i is incremented by 1. Otherwise, the flow in FIG. 5 ends.

By the processing from step S008 to step S020, similarity between image data A and B is calculated as the value of variable P(A, B). Movement-vector-based similarity score calculating unit 106 stores the value of variable P(A, B) calculated in the above described manner at a prescribed address of memory 1022, and transmits a similarity score calculation end signal to control unit 108 to end the process.

Referring to FIG. 4 again, processing in step S106 in FIG. 4 is performed to determine whether the data A and B match with each other or not, using the similarity score calculated in the collation processing in FIG. 5. Specifically, the similarity score given as a value of variable P(A, B) stored in at the prescribed address in memory 102 is compared with a predetermined collation threshold T. If the result of comparison is P(A, B)≧T, it is determined that both data A and B were obtained from the same fingerprint, and values of ordidx and datidx are written as a result of collation into a prescribed address of memory 1022 (step S108). Otherwise, 1 is added to the value of ordidx (step S107), and the processing starting from step S102 is repeated.

When it is determined in step S102 that updated ordidx is not smaller than number NREF of the reference data, this means that there is no reference data matching with input data A. In this case, a value, e.g., of “−1” representing “mismatching” is written into a prescribed address of calculation memory 1022 (step S109). Further, the collation determination end signal is transmitted to control unit 108, and the process ends.

FIG. 6 is a flowchart for illustrating the collation order updating processing, which is a subroutine executed in step T4 of FIG. 3. The purpose of this processing is to put the reference data determined as “matching” by the collation determination at the first place in the reference order of the collation order table, and thereby to use this reference data first in the next collation determination processing (see FIG. 4).

FIGS. 7A and 7B illustrate an example of the collation order table. In FIGS. 7A and 7B, A-D represent memory addresses at which the reference data are stored corresponding to the respective indexes. In the following description, the reference data itself stored at the respective memory addresses are referred to as the “reference data A-D”.

FIGS. 7A and 7B illustrate the example in which the collation place of reference data C of index 2 is updated to the first place in the collation order, i.e., index 0. Referring to FIGS. 6, 7A and 7B, the collation order updating processing will now be described.

First, in step U101, a result of collation, which is written in step S108 or S109, is read from calculation memory 1022, and it is determined whether the result of collation represents “mismatching” or not. If it represents “mismatching”, a collation order updating end signal is transmitted to control unit 108 to end the processing. If it is determined in step U101 that the result represents “matching”, the flow proceeds to step U102.

In step U102, the value of variable j is initialized to index ordidx which is attained in the collation order table at the time of the matching of the reference data. In other words, the value of variable j is updated to the value of ordidx which is written as the collation result into the prescribed address of calculation memory 1022 in step S108.

For example, when calculation memory 1022 has stored the collation results representing that the collation target data matches with reference data C in FIG. 7A, the value of variable j is initialized to index “2”.

In step U103, the value of variable j is compared with 0. If j is larger than 0, processing from step U103 to step U105 is performed. When j becomes equal to 0, processing in step U106 is performed. For example, if variable j is “2”, the flow proceeds to step U104.

In step U104, the value of Order[j−1] is written into Order[j]. For example, when j is “2” in the collation order table of FIG. 7A, the reference data corresponding to index “2” is replaced with reference data B corresponding to index “1”.

In step U105, 1 is subtracted from the value of j, and the processing starting from step U103 is repeated. Consequently, in the collation order table, e.g., of FIG. 7A, the reference data corresponding to index “1” is replaced with reference data A corresponding to index “0”.

In step U106, index datidx of the reference data at the time of matching is written into Order[0]. Thereby, the matching reference data becomes a first element in the collation order data. For example, in the collation order table of FIG. 7A, the reference data corresponding to index “0” is replaced with reference data C which is the reference data at the time of matching. Consequently, the collation order table is updated as illustrated in FIG. 7B. Collation processing unit 11 transmits a collation order updating end signal to control unit 108 to end the processing.

### Second Embodiment

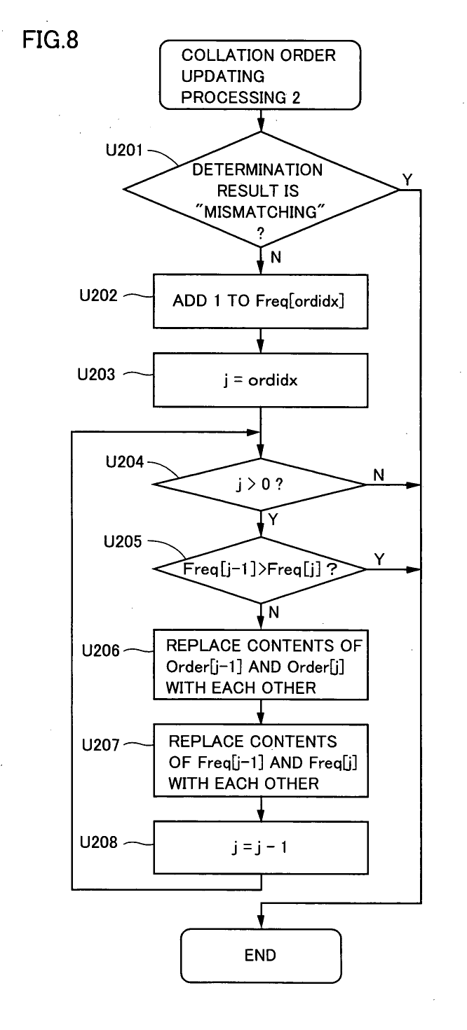

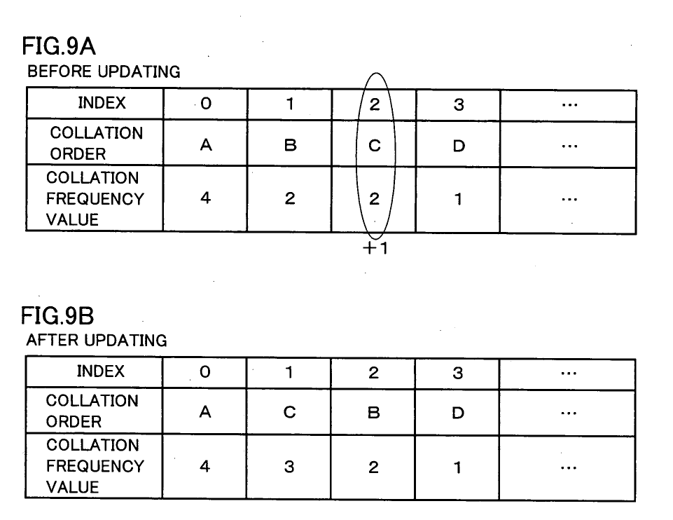

A second embodiment will now be described with reference to FIGS. 8, 9A and 9B. Biometric information collating apparatus 1 according to the second embodiment differs from that of the first embodiment in that the collation order table corresponding to that stored in biometric information collating apparatus 1 according to the first embodiment additionally stores collation frequency values, i.e., values representing the frequencies of determination as “matching” in the collation determination processing for the respective reference data. The table representing the relationship between the collation frequency values and the respective reference data will be referred to as the “collation frequency table” hereinafter. Biometric information collating apparatus 1 according to the second embodiment has the same hardware structure as that of the first embodiment.

In response to every determination as “matching” in the collation determination, collation processing unit 11 adds a predetermined value (e.g., of “1”) to the collation frequency value of the reference data determines as “matching”. Therefore, a larger collation frequency value represents a higher collation frequency. In this second embodiment, the reference order of the reference data is updated in the descending order of the collation frequency.

FIGS. 9A and 9B illustrate the collation order table stored in biometric information collating apparatus 1 according to the second embodiment. The collation order table illustrated in FIGS. 9A and 9B include the collation frequency table representing the collation frequency values of the respective reference data. Collation order storing unit 1024 stores this collation order table. For example, FIG. 9A illustrates the collation order table of the collation order before updating. FIG. 9B illustrates the collation order table of the collation order after the updating. FIGS. 9A and 9B illustrate an example of the collation order table in which the place in the collation order of reference date C of index 2 is updated from the third place to the second place 2.

The procedures of the collation processing executed by biometric information collating apparatus 1 of the second embodiment are substantially the same as those of the collation processing of the first embodiment. Therefore, biometric information collating apparatus 1 of the second embodiment executes the processing illustrated in FIGS. 4 and 5. However, the contents of the collation order updating processing in step T4 of FIG. 3 are different from those of the first embodiment. In the first embodiment, the place in the reference order of the reference data is updated to the first place when it is determined as “matching” in the collation determination. In the second embodiment, however, the order of the reference data is changed in the descending order of the frequency of the matching. FIG. 8 illustrates a flowchart of the procedures of the collation order updating processing 2 according to the second embodiment.

Referring to FIGS. 8, 9A and 9B, the flowchart of the collation order updating processing 2 will now be described in detail. In the following description, the first element in the collation frequency table is expressed as Freq[0], and the next element is expressed as Freq[1]. For example, Freq[0] in FIG. 9A means the collation frequency value “4” of reference data A corresponding to index “0”. When biometric information collating apparatus 1 is produced (i.e., when memory 102 is initialized), the collation frequency values of the respective reference data are initialized to appropriate values (e.g., all zero).

In step U201, the result of the collation, which was written in step S108 or S109, is read from calculation memory 1022, and it is determined whether the collation result is “mismatching” or not. If “mismatching”, the collation order updating end signal is transmitted to control unit 108, and the processing ends. If it is determined in step U201 that the collation result is “matching”, the flow proceeds to step U202.

In step U202, a predetermined updating value is added to collation frequency value Freq[ordidx] corresponding to index ordidx in the collation order table at the time of matching of the reference data. In connection with this, ordidx is a value which is written as the collation result into a prescribed address of calculation memory 1022 in step S108. The updating value is, e.g., “1”.

When calculation memory 1022 has stored the collation result representing the matching of the collation target data with reference data C in FIG. 9A, collation frequency value Freq[2] corresponding to reference data C of index “2” is updated from “2” to “3”, e.g., in step U202.

The updating value is not restricted to “1”. Normalization may be performed such that a sum of all the collation frequency values in the collation frequency table may take a constant value, and the collation frequency value may be a stochastic value.

In step U203, the value of variable j is initialized to index ordidx in the collation order table appearing at the time of matching of the reference data. In other words, the value of variable j is updated to the value of ordidx which is written as a collation result into the prescribed address of calculation memory 1022 in step S108.

For example, when calculation memory 1022 has stored the collation result representing the matching of the collation target data with reference data C in FIG. 9A, the value of variable j is initialized to index “2”.

In step U204, the value of variable j is compared with 0. While j is larger than 0, the flow proceeds to step U205. When j matches with 0, the collation order updating end signal is transmitted to control unit 108, and the processing ends. For example, when variable j is “2”, the flow proceeds to step U205.

In step U205, the value of Freq[j−1] is compared with the value of Freq[j]. If the former is larger than the latter, the collation order updating end signal is transmitted to control unit 108. Otherwise, processing in step U206 is performed.

For example, when a comparison is made between the values of Freq[2−1] and Freq[2] in FIG. 9A, the former is “2” and the updated latter is [2+1] so that the processing in step U206 is performed.

In step U206, the values of Order[j−1] and Order[j] are replaced with each other in the collation order table. Order[j] means the reference data in the collation order table corresponding to index j. In subsequent step U207, the values of Freq[j−1] and Freq[j] are replaced with each other in the collation frequency table.

For example, the values of Order[2−1] and Order[2] are replaced with each other in FIG. 9A, and further the values of Freq[2−1] and Freq[2] are replaced with each other so that the collation order table in FIG. 9A is updated as illustrated in FIG. 9B.

In step U208, 1 is subtracted from the value of j, and the processing in and after step U204 is repeated. Consequently, in the updated collation order table, e.g., in FIG. 9B, a comparison is further made between the collation frequency value of the reference data corresponding to index “0” and the collation frequency value of the reference data corresponding to index “ 1”. In this case, the result of determination in step U205 is “YES”. Consequently, the collation order updating end signal is transmitted to control unit 108, and the processing ends.

According to the second embodiment, the reference order of the reference data is updated in the descending order of the frequency of matching as a result of the collation determination. Therefore, the collation determination can be performed by successively referring to the reference data in the descending order of the probability of matching. Consequently, the time of the collation processing can be reduced on average.

### Third Embodiment

The processing function for collation already described are achieved by programs. According to a third embodiment, such programs are stored on computer-readable recording medium.

In the third embodiment, the recording medium may be a memory required for processing by the computer show in FIG. 2 and, for example, may be a program medium itself such as memory 624. Also, the recording medium may be configured to be removably attached to an external storage device of the computer and to allow reading of the recorded program via the external storage device. The external storage device may be a magnetic tape device (not shown), FD drive 630 or CD-ROM drive 640. The recording medium may be a magnetic tape (not shown), FD 632 or CD-ROM 642. In any case, the program recorded on each recording medium may be configured such that CPU 622 accesses the program for execution, or may be configured as follows. The program is read from the recording medium, and is loaded onto a predetermined program storage area in FIG. 2 such as a program storage area of memory 624. The program thus loaded is read by CPU 624 for execution. The program for such loading is prestored in the computer.

The above recording medium can be separated from the computer body. A medium stationarily bearing the program may be used as such recording medium. More specifically, it is possible to employ tape mediums such as a magnetic tape and a cassette tape as well as disk mediums including magnetic disks such as FD 632 and fixed disk 626, and optical disks such as CD-ROM 642, MO (Magnetic Optical) disk, MD (Mini Disk) and DVD (Digital Versatile Disk), card mediums such as an IC card (including a memory card) and optical card, and semiconductor memories such as a mask ROM, EPROM (Erasable and Programmable ROM), EEPROM (Electrically EPROM) and flash ROM.

Since the computer in FIG. 2 has a structure, which can establish communication over communication network 300 including the Internet. Therefore, the recording medium may be configured to bear flexibly a program downloaded over communication network 300. For downloading the program over communication network 300, a program for download operation may be prestored in the computer itself, or may be preinstalled on the computer itself from another recording medium.

The form of the contents stored on the recording medium is not restricted to the program, and may be data.

According to the invention relating to the embodiments already described, the order of the collation of the reference data with the input collation target data is dynamically changed so that it can be expected to reduce the quantity of processing of the data collation. This effect is particularly effective in the case where the reference data is used in an unbalanced fashion. The precise biometric information collation, which is less sensitive to presence/absence of minutiae, number and clearness of images, environmental change at the time of image input, noises and others, can be performed in a short collation time with reducible power consumption. The reduction of processing is automatically performed, and this effect can be maintained without requiring the maintenance of the device.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A biometric data collating apparatus comprising:
a collation target data input unit receiving biometric collation target data;
a collation data storing unit storing a plurality of collation data used for collating the collation target data received by said collation target data input unit and an order of collation of said plurality of collation data;
a collating unit reading each of the collation data stored in said collation data storing unit in said collation order, and collating the read collation data with the collation target data received by said collation target data input unit; and
a collation order updating unit updating the collation order to put the collation data determined as matching data from the result of the collation by the collating unit in a leading place.

2. The biometric data collating apparatus according to claim 1, wherein
said collation target data and said collation data are images.

3. The biometric data collating apparatus according to claim 2, wherein
said image is a fingerprint image.

4. A biometric data collating apparatus comprising:
a collation target data input unit receiving biometric collation target data;
a collation data storing unit storing a plurality of collation data used for collating the collation target data received by said collation target data input unit and priority values representing degrees of priority of collation for the respective collation data;
a collating unit reading each of the collation data stored in said collation data storing unit in a descending order of the degree of the priority represented by said priority value, and collating the read collation data with the collation target data received by said collation target data input unit; and
a priority value updating unit updating and changing the priority value corresponding to the collation data determined as matching data from the result of the collation by the collating unit into a value representing a higher degree of the priority.

5. The biometric data collating apparatus according to claim 4, further comprising:
a collation order updating unit updating the collation order of each of the collation data in the descending order of the degree of the priority represented by the priority value corresponding to said collation data, wherein
said collating unit reads the respective collation data in said collation order, and collates the read collation data with said collation target data received by said collation target data input unit, and
when the updated priority value corresponding to the collation data determined as the matching data from the result of the collation by said collating unit is larger than or equal to the priority value corresponding to the collation data preceding in the collation order said collation data determined as the matching data, said collation order updating unit replaces the places in the collation order of said two collation data with each other.

6. The biometric data collating apparatus according to claim 5, wherein
said collation target data and said collation data are images.

7. The biometric data collating apparatus according to claim 6, wherein
said image is a fingerprint image.

8. A biometric data collating method comprising:
a collation target data input step of receiving biometric collation target data;
a collating step of reading, in a collation order of a plurality of collation data, each of the collation data stored in a collation data storing unit storing said plurality of collation data used for collating the collation target data received in said collation target data input step and said collation order of said plurality of collation data, and collating the read collation data with the collation target data received in said collation target data input step; and
a collation order updating step of updating the collation order to put the collation data determined as matching data from the result of the collation in said collating step in a leading place.

9. A biometric data collating method comprising:
a collation target data input step of receiving biometric collation target data;
a collating step of reading, in a descending order of a degree of a priority represented by a priority value of a collation data, each of the collation data stored in a collation data storing unit storing said plurality of collation data used for collating the collation target data received in said collation target data input step and said priority values representing the degrees of priority of collation for the respective collation data, and collating the read collation data with the collation target data received in said collation target data input step; and
a priority value updating step of updating and changing the priority value corresponding to the collation data determined as matching data from the result of the collation in said collating step into a value representing a higher degree of the priority.

10. A biometric data collating program product causing a computer to execute:
a collation target data input step of receiving biometric collation target data;
a collating step of reading, in a collation order of a plurality of collation data, each of the collation data stored in a collation data storing unit storing said plurality of collation data used for collating the collation target data received in said collation target data input step and said collation order of said plurality of collation data, and collating the read collation data with the collation target data received in said collation target data input step; and
a collation order updating step of updating the collation order to put the collation data determined as matching data from the result of the collation in said collating step in a leading place.

11. A biometric data collating program product causing a computer to execute:
a collation target data input step of receiving biometric collation target data;
a collating step of reading, in a descending order of a degree of a priority represented by a priority value of a collation data, each of the collation data stored in a collation data storing unit storing said plurality of collation data used for collating the collation target data received in said collation target data input step and said priority values representing the degrees of priority of collation for the respective collation data, and collating the read collation data with the collation target data received in said collation target data input step; and
a priority value updating step of updating and changing the priority value corresponding to the collation data determined as matching data from the result of the collation in said collating step into a value representing a higher degree of the priority.
